(19) United States
(12) Patent Application Publication
(10) Pub. No.: US 2022/0263441 A1
(43) Pub. Date: Aug. 18, 2022

(54) Motor Controller

(71) Applicant: AISAN KOGYO KABUSHIKI KAISHA, Obu-shi (JP)

(72) Inventors: Nobuhiro KATO, Tokai-shi (JP); Satoshi NAKAMURA, Ichinomiya-shi (JP); Hiroyuki YAMAUCHI, Nagoya-shi (JP); Takahiko IWAKURA, Aichi-gun (JP)

(73) Assignee: AISAN KOGYO KABUSHIKI KAISHA, Obu-shi (JP)

(21) Appl. No.: 17/669,329

(22) Filed: Feb. 10, 2022

(30) Foreign Application Priority Data
Feb. 18, 2021 (JP) 2021-024279

(51) Int. Cl. H02P 8/38; F01P 7/04; H02P 1/16; F02D 41/20

(52) U.S. Cl. CPC H02P 8/38; F02D 41/20; H02P 1/16; F01P 7/04

(57) ABSTRACT

A motor controller includes a temperature sensor configured to detect a temperature of a motor. An intermittent operation circuit allows the motor to intermittently operate at a rotation speed up to a phase before the motor reaches a rated rotation speed when it is detected that the motor temperature is at a low temperature range. The intermittent operation circuit includes a position fixing circuit configured to allow a constant electric current to flow through stator coils and to fix the motor in a stopped state. The intermittent operation circuit further includes a forced commutation circuit that allows the motor to rotate at a rotation speed up to the start-up rotation. The position fixing circuit allows the constant electric current to have a greater value as the temperature detected by the temperature sensor is lower, and allows the position fixing circuit and the forced commutation circuit to operate alternately.

### CROSS-REFERENCE TO RELATED APPLICATIONS

This application claims priority to Japanese patent application serial number 2021-024279, filed Feb. 18, 2021, which is incorporated herein by reference in its entirety for all purposes.

### STATEMENT REGARDING FEDERALLY SPONSORED RESEARCH OR DEVELOPMENT

Not applicable.

### BACKGROUND

The disclosure relates generally to a motor controller that serves to operate a pump.

One method for warming-up a motor may allow the motor to start at a low temperature. According to the method, an electric current is allowed to flow through all coils of the motor to generate heat without moving the motor. Further, an air conditioner includes a motor-driven air mix door. For achieving quick heating in a passenger compartment, the motor is rotated for a short time each time a plurality of set temperatures has been reached in order to move the air mix door as much as it can.

### SUMMARY

One embodiment disclosed herein includes a temperature sensor configured to detect a temperature of a motor itself or a temperature around the motor. A normal operability determining circuit is configured to determine that the motor is in a normally operable state. The normally operable state is where it is not necessary to consider whether the motor is operating at a low temperature. An intermittent operation circuit allows the motor to intermittently operate at a rotation speed up to a predetermined start-up rotation speed. The predetermined start-up rotation speed is a speed at a phase before the motor reaches a rated rotation speed. The intermittent operation of the motor continues until the normal operability determining circuit detects the motor is in a normally operable state. The intermittent operation of the motor may occur when the temperature detected by the temperature sensor is detected as being in a low temperature range during the operation of the motor. The intermittent operation circuit includes a position fixing circuit that allows a constant electric current to flow through stator coils of the motor, so as to fix the motor in a stopped state. Further, the intermittent operation circuit includes a forced commutation circuit to allow the motor to rotate at the rotation speed up to the start-up rotation speed. The position fixing circuit sets the constant electric current in accordance with the temperature detected by the temperature sensor. The electric current value may be set higher if the temperature is lower. The position fixing circuit also allows the position fixing circuit and the forced commutation circuit to operate alternately.

Therefore, the motor is intermittently operated at the rotation speed up to the predetermined start-up rotation speed. As noted above, the predetermined start-up rotation speed is a speed that is at the phase before the rotation of the motor reaches its rated rotation speed. The motor is intermittently operated when the motor is operated in a low temperature range. This causes a relatively high start-up electric current to repeatedly flow through the coils of the motor, thereby achieving an efficient warming-up of the motor. In addition, at this time, the motor is heated while rotating. As a result, an electric current of a sequentially varying magnitude flows through the coils of the motor, thereby preventing the coils from overheating locally. Further, the motor is rotated while being repeatedly heated at a lower rotation speed, which may be up to the start-up rotation speed. Therefore, the grease can settle to allow for better rotation of the bearings, for instance due to the lowered viscosity of the grease, which also results in suppressing the abnormal noise, vibration, etc., which is peculiar to the low-temperature operation of motors. Further, constant electric currents (for instance the first electric current and second electric current) are allowed to flow through the stator coils of the motor between each starting event of the motor by the intermittent operation, which may be done to stop the motor. The constant electric current is made to be higher as the temperature of the motor is lower. Therefore, even while the motor is stopped, it can be heated significantly despite its low temperature state, thereby enabling promotion of the warming up of the motor. On the other hand, heating of the motor is suppressed when it is in a high temperature state, such that the overheating of the stator coil can be prevented. As a result, the normal motor operation can be quickly started.

Embodiments disclosed herein may include a position fixing circuit, which includes a guiding circuit. The guiding circuit allows the first electric current to have a value greater than the rated electric current and smaller than the electric current flowing through the stator coils of the motor when rotated by the forced commutation circuit. This first electric current is allowed to flow through one or some predetermined plurality of stator coils among the stator coils of the motor. The guiding current also guides the rotor of the motor toward a stop position. The position fixing circuit further includes a stop fixing circuit. The stop fixing circuit allows the second electric current to have a value greater than the first electric current and smaller than the electric current flowing through the stator coil of the motor when it is rotated by the forced commutation circuit. The second current may be allowed to flow through all the stator coils of the motor. The stop fixing current may be configured to stop the rotor of the motor at the stop position.

Therefore, the rotor is rotated and guided toward a predetermined stop position by the guiding circuit, regardless of the rotation position of the rotor and regardless of whether or not the rotor is rotating. The rotor is then stopped at a predetermined stop position by the stop fixing circuit. This ensures the rotor has been stopped, regardless of the state of the rotor. In addition, the forced commutation can be smoothly started by selecting the stop position at the position where the rotation of the motor under the forced commutation control process can be smoothly performed.

Embodiments disclosed herein may include a position fixing means that includes a guiding circuit and stop fixing circuit. The guiding circuit allows the first electric current to have a value greater than the rated electric current and smaller than the electric current flowing to the stator coils of the motor when the rotor is rotated by the forced commutation circuit. The current is allowed to flow through one or some predetermined stator coils among the plurality of stator coils of the motor. The guiding circuit is configured to guide the rotor of the motor toward a stop position. The stop fixing circuit allows the third electric current to have a value greater than the rated electric current and smaller than the electric current flowing to the stator coils of the motor rotated by the forced commutation circuit. The current may be allowed to flow through all the stator coils of the motor. The stop fixing circuit is configured to stop the rotor of the motor at the stop position. The third electric current applied by the stop fixing circuit is gradually increased from the start of energizing. For instance, it may be set to be initially smaller than the first electric current, and to gradually increase so as to be finally greater than the first electric current.

Therefore, the guiding circuit allows the rotor to be rotated and guided toward the predetermined stop position. The stop fixing circuit stops the rotor at the predetermined stop position. At this time, the stop fixing circuit gradually increases the electric current flowing to the stator coils, from the state smaller than the first electric current to the state greater than the first electric current. This ensures the rotor is stop stably.

Embodiments disclosed herein may include an intermittent operation circuit. The intermittent operation circuit may include an interval circuit to allow the operation starting of the position fixing circuit to wait for a certain standby time after the forced commutation circuit has been operated. The standby time of the interval circuit is set to be longer as the temperature of the motor itself or the temperature around the motor becomes higher.

Therefore, as the temperature increases, the standby time of the interval circuit is elongated, which in turn elongates the intermittent cycle of the start-up drive for allowing the start-up rotation of the motor. This enables an appropriate warming-up, without the stator coils of the motor being overheated.

Some embodiments disclosed herein include a temperature range determining circuit and a high-speed rotation circuit. The temperature range determining circuit serves to determine if the temperature detected by the temperature sensor is in an extremely low temperature range, which is less than a predetermined first temperature. The temperature range determining circuit is also configured to determine if the temperature is in a low temperature range, which is between the first temperature and a second temperature that is greater than the first temperature. The temperature range determining circuit is further configured to determine if the temperature is in a middle temperature range, which is between the second temperature and a third temperature that is greater than the second temperature. The high-speed rotation circuit includes a motor stopping circuit and a high-speed rotation circuit. If the temperature range determining circuit determines that the temperature is in the extremely low temperature range, the motor stopping circuit stops the motor. If the temperature range determining circuit determines that the temperature is in the middle temperature range, the high-speed rotation circuit allows the motor to rotate at higher speed that is greater than the rotation speed by the forced commutation circuit and less than the rated rotation speed. If the temperature range determining circuit determines that the temperature is in the low temperature range, the intermittent operation circuit allows the motor to intermittently operate.

Therefore, in the low temperature range, the start-up rotation of the motor is intermittently performed such that the normal motor operation can be quickly started. In the extremely low temperature range, the motor is not be forced to start. In the middle temperature range, the grease for the bearings is settled for rotation in a short time by rotating the motor at high speed that is greater than the start-up rotation. Therefore, it is possible to start the normal motor operation as quickly as possible by the temperature dependent control.

Some embodiments disclosed herein include a normal operability determining circuit. The normal operability determining circuit may be configured to determine if the motor is in a normally operable state, for instance, based on whether one or more of the following conditions are satisfied: (i) that greater than the predetermined time has elapsed after the intermittent operation circuit started operating, (ii) that the temperature of the motor itself or the temperature around the motor is greater than or equal to the normally operable temperature that does not require the system to take into account that the motor is operating at a low temperature, (iii) that the operating electric current under the rated load of the motor is less than or equal to the predetermined electric current, (iv) if the number of intermittent operation times by the intermittent operation circuit is greater than or equal to the predetermined number of times, or (v) combinations thereof.

Therefore, the normally operable state of the motor can be accurately determined based on the progress state of the warming-up of the motor and the number of intermittent initiation times of the motor. This enables the motor to be transferred to the normal operation at an appropriate timing.

### BRIEF DESCRIPTION OF THE DRAWINGS

FIG. 1 is a schematic view of an embodiment of a control circuit diagram of a pump driving motor.

FIG. 2 is a flow chart illustrating an embodiment of a process for controlling the pump driving motor of FIG. 1 when warming-up the pump driving motor.

FIG. 3 is a graphical illustration of the rotational speed of the pump driving motor of FIG. 1 as a function of time when warming-up the pump driving motor according to FIG. 2.

FIG. 4 is a flow chart illustrating an embodiment of a position fixing control process for use in the process of FIG. 2.

FIG. 5 is a table of a map for determining an electric current value for the position fixing control process of FIG. 4 for the pump driving motor of FIG. 1.

FIG. 6 is a graphical illustration of the electric current value of the pump driving motor of FIG. 1 as a function of time while the pump driving motor is under position fixing control process of FIG. 4, and a schematic diagram illustrating the relative positional relationship between a stator and a rotor of the motor of FIG. 1 during the position fixing control process of FIG. 4.

FIG. 7 is a schematic view illustrating the relative positional relationship between the stator and the rotor of the pump driving motor of FIG. 1 when warming up the pump driving motor according to the process of FIG. 2.

FIG. 8 is a flow chart illustrating an embodiment of a position fixing control process for use in the process of FIG. 2.

FIG. 9 is a graphical illustration of the electric current values of the pump driving motor of FIG. 1 as a function of time while the pump driving motor during the position fixing control process of FIG. 8, and a schematic diagram illustrating the relative positional relationship between the stator and the rotor for the pump driving motor during the position fixing control process of FIG. 8.

FIG. 10 is a flow chart illustrating an embodiment of a process for controlling the pump driving motor of FIG. 1 when warming-up the pump driving motor of FIG. 1.

FIG. 11 is a flowchart illustrating an embodiment of a process for controlling the pump driving motor of FIG. 1 when warming-up the pump driving motor of FIG. 1.

FIG. 12 is a flow chart illustrating an embodiment of a process for controlling the pump driving motor of FIG. 1 when warming-up the pump driving motor of FIG. 1.

FIG. 13 is a table illustrating contents of a control time map for warming up the pump driving motor of FIG. 1 according to the process of FIG. 12.

FIG. 14 is a flow chart illustrating an embodiment of a process for controlling the pump driving motor of FIG. 1 when warming up the pump driving motor of FIG. 1.

FIG. 15 is a graphical illustration of the rotation speed of the pump drive motor of FIG. 1 as function of time when warming up the pump driving motor according to the process of FIG. 14.

FIG. 16 is a table of a standby time map for warming up the pump driving motor of FIG. 1 according to the process of FIG. 14.

FIG. 17 is a flow chart illustrating an embodiment of a process for controlling the pump driving motor of FIG. 1 when warming up the pump driving motor of FIG. 1.

FIG. 18 is a diagram illustrating the temperature operational ranges for the warming up process of FIG. 17.

FIG. 19 is a schematic view of an engine.

### DETAILED DESCRIPTION

Warming-up a motor by energizing coils may lead to a local overheating of the coils, which may possibly result in a failure of the motor. Further, if the rotation speed of the motor is increased at a low temperature, abnormal noise or vibration may be generated, which may deteriorate the durability of the motor.

Accordingly, there is a need for a technique that allows the grease in the bearings of a rotating shaft of a motor to be settled to allow the motor to quickly start a normal operation while operating the motor at a low temperature condition. There has especially been a need for settling grease by repeatedly performing the start-up operation prior to the motor reaching a rated rotation speed when operating at a low temperature while suppressing abnormal noise or vibrations.

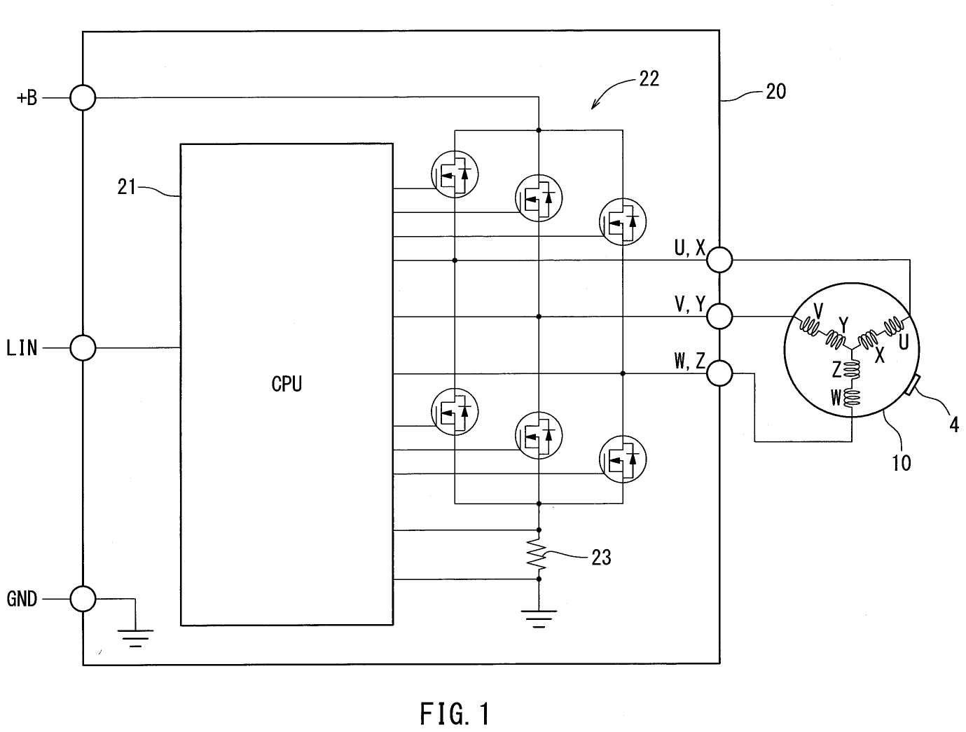

As shown in FIG. 1, a first embodiment of a motor 10 is a pump driving motor. More specifically, the pump, which is driven by the pump driving motor, is a purge pump for a vehicle engine. The purge pump serves to feed fuel vapor from within a fuel tank (not shown) that had been adsorbed and captured by a canister (not shown) to an intake passage (not shown) of the engine.

The motor 10 is a three-phase brushless motor with two poles and six slots. The motor 10 is rotatably operated by a motor driving circuit 20. The motor driving circuit 20 includes a three-phase inverter circuit 22 and a control circuit 21. The control circuit 21 includes a digital computer configured to control the three-phase inverter circuit 22. The three-phase inverter circuit 22 controls energizing of each stator coil of a stator of the motor 10. The stator coils may generally be connected in a Y-shaped configuration. The control circuit 21 is programed to control the rotational speed of the motor 10. The control circuit 21 may also be programmed to control the electric current of each stator coil, etc., as is known in the art. A shunt resistor 23 for detecting and/or measuring electric currents is connected on a ground side of the three-phase inverter circuit 22. The detection/measurement signals are input to the control circuit 21. In the motor driving circuit 20, “LIN” represents a rotation speed indication signal input terminal, “+B” represents a power supply terminal, and “GND” represents a grounding terminal.

Each transistor for the three-phase inverter circuit 22 is controlled and switched by the control circuit 21. The transistors are switched at a time when the purge pump is to be operated, such that the motor 10 is rotatably operated. The rotation speed of the motor 10 is controlled in accordance with signals input to the rotation speed indication signal input terminal LIN.

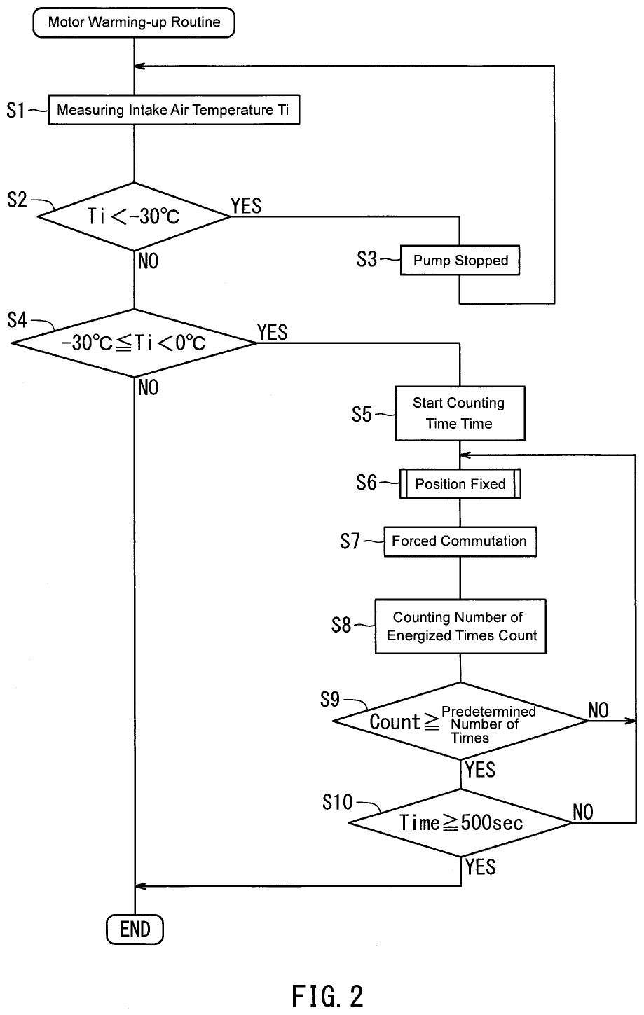

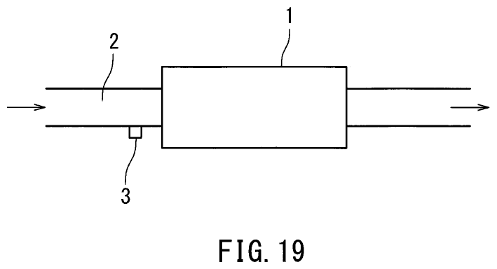

FIG. 2 shows a first embodiment of a process for warming up the motor 10, which may be one of the processes controlled by programs for a digital computer of the control circuit 21. The motor warming-up process shown in FIG. 2 may be configured to be executed when the engine 10 is cold. In particular, the intake air temperature Ti is measured with an intake air temperature sensor 3 (which is one example of a temperature detecting sensor) positioned in an intake passage 2 (see FIG. 19) of an engine 1 (e.g., engine 10) in Step S1. In this embodiment, the measured intake air temperature Ti is representative of the temperature around or proximal the motor 10. In Step S2, it is determined whether the intake air temperature Ti is below a predetermined temperature, such as below −30° C. If the intake air temperature Ti is below −30° C., Step S2 is determined to be YES, and the pump is stopped in Step S3. In other words, the motor 10 is not operated or stopped from being operated. As such, if the intake air temperature Ti is below −30° C., the motor 10 is not operated, thereby preventing deterioration of the motor 10 due to abnormal noise or vibrations generated when the motor 10 is operated at such a low temperature.

As shown in FIG. 2, if Step S2 is determined to be NO because the intake air temperature Ti is greater than the predetermined temperature, for instance being greater than or equal to −30° C., the process proceeds to Step S4. In Step S4, it is determined whether the intake air temperature Ti is within a certain range, for instance whether the intake air Ti is greater than or equal to −30° C. and less than 0° C. If the intake air temperature Ti is greater than or equal to −30° C. and less than 0° C., Step S4 is determined to be YES and the process proceeds to Step S5. In Step S5, a timer starts counting Time. In the subsequent Step S6, a position fixing control process is carried out. The position fixing control process functions to fix a rotation position of a stator of the motor 10. In particular, the rotation position of the stator can be fixed at a predetermined position. Further, in Step S7, a forced commutation control process is carried out. The forced commutation control process operates and rotes the motor 10 at a predetermined rotation speed. For example, the motor 10 may be rotated with a start-up rotation speed in a phase before reaching 40,000 to 50,000 rpm, for example at a rotation speed up to 10,000 rpm.

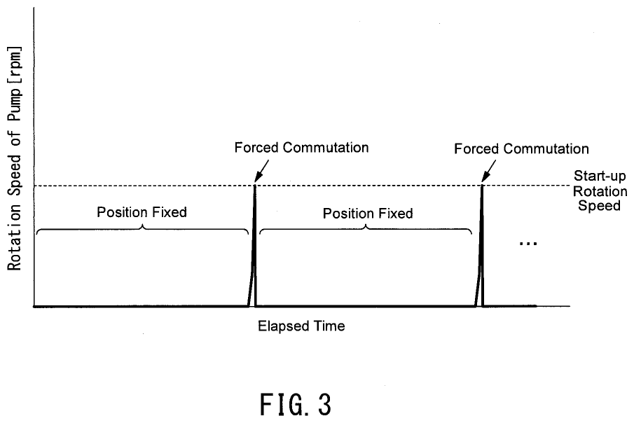

As shown in FIG. 2, in Step S8, the number of times the motor 10 has been energized during the forced commutation control process is counted. In the subsequent Step S9, it is determined whether the Count of the number of times the motor has been energized has reached a predetermined number, for example, 400 times. Further, in the subsequent Step S10, it is determined whether the timer Time has reached a predetermined time, for example, 500 seconds. If the Count of the number of times the motor has been energized has not reached the predetermined number of times or if the timer Time has not reached the predetermined time, Step S9 and/or Step S10 is determined to be NO and the process from Step S6 and onward will be repeated. Therefore, as shown in FIG. 3, the above position fixing control process and the above forced commutation control process will be repeatedly executed. More specifically, the motor is operated intermittently at a rotation speed up to the predetermined start-up rotation speed. If Step S9 and Step S10 are both determined to be YES (i.e., Count of the number of times the motor has been energized has reached the predetermined number of times and the timer Time has reached the predetermined time), the process for warming-up the engine 10 ends.

The process of Step S1 in FIG. 2 corresponds to a temperature detecting means of a first means. The processes of Steps S5, S8, S9, and S10 correspond to a normal operability determining means (for example, a normal operability determining circuit, which is a part of a control circuit (CPU) 21). The processes of Steps S5, S6, S7, S8, S9, and S10 correspond to an intermittent operation means (for example, an intermittent operation circuit, which is a part of the CPU 21). The process of Step S6 corresponds to a position fixing means (for example, a position fixing circuit, which is a part of CPU 21), and the process of Step S7 corresponds to a forced commutation means (for example, a forced commutation circuit, which is a part of the CPU 21).

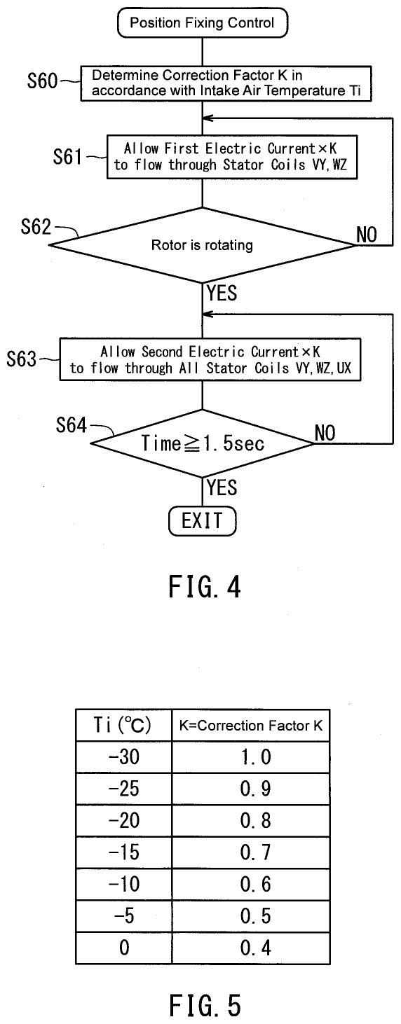

FIG. 4 shows an embodiment of the position fixing control process of Step S6 in FIG. 2. When the position fixing control process starts, a correction factor K for the electric current to flow through the stator coils is determined based on the intake air temperature Ti in Step S60. The correction factors K may be stored in a memory unit of a computer. The correction factors K may be stored in a map in advance. FIG. 5 shows an embodiment of such a map for storing the correction factors K. As shown in FIG. 5, the correction factors K are set in accordance with the intake air temperature Ti. For example, the correction factors K are set such that the lower the intake air temperature Ti, the greater the value of the correction factor K. The correction factors K corresponding to temperatures between the temperatures stored in the map can be obtained by complementation, for instance based on the assumption that they vary with the same gradient as the difference between the correction factors K for each stored temperature.

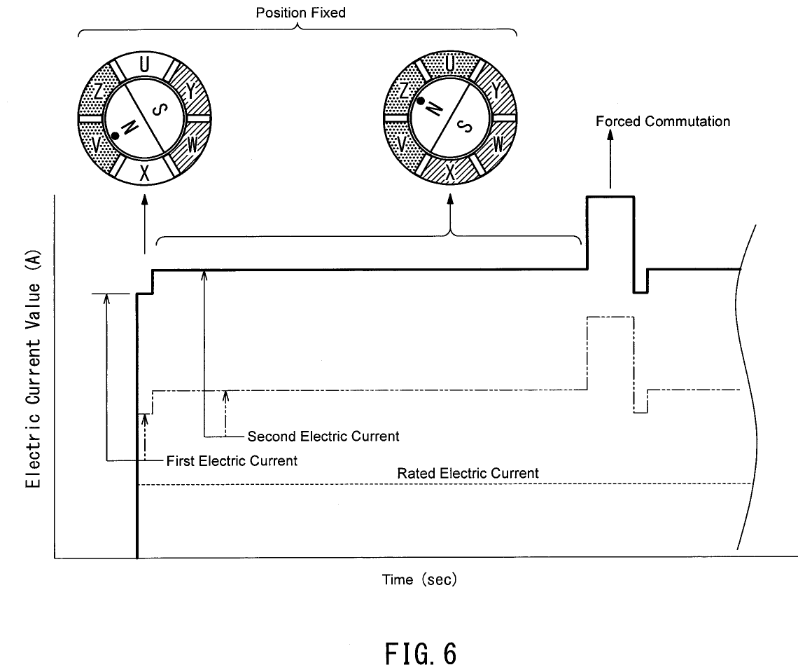

In Step S61 in FIG. 4, the first electric current is corrected by the correction factor K (i.e., by multiplying the correction factor K and the first electric current) and allowed to flow through two phases, for instance phase VY and phase WZ, among three-phases of the stator coils of the motor 10. The electric current value of the stator coil is duty ratio controlled or controlled by duty cycle. If the intake air temperature Ti is as low as −30° C., the corrected first electric current is two to three times greater than the rated electric current and smaller than the electric current that flows to each stator coil of the motor 10 in the above mentioned forced commutation control process (see solid line in FIG. 6). If the intake air temperature Ti is 0° C., the corrected first electric current will be at a value indicated by a virtual (dashed) line in FIG. 6. More specifically, the value will be 0.4 times the first electric current if the intake air temperature Ti had been −30° C. Accordingly, the corrected first current would be greater than the rated electric current. If the intake air temperature Ti is between −30° C. and 0° C., the corrected first electric current may be at a value between the value indicated by a solid line and a value indicated by a virtual line in FIG. 6.

As a result, the rotor of the engine 10, which is made of permanent magnets (indicated by N and S in FIG. 6), is induced to rotate toward the predetermined stop position, regardless of the rotation position before the stator coils are energized during Step S61. In FIG. 6, the energized stator coils are indicated with hatching and dots, while the stator coils not being energized are distinguished by being indicated with a white space (no fill pattern). As a result of the energizing electric current, the stator is excited to the N-pole on the hatched side and to the S-pole on the dotted side.

When the rotor is rotating due to the first electric current, Step S62 in FIG. 4 is determined to be YES. In Step S63, a second electric current, which has been corrected by the correction factor K, is then allowed to flow through all three phases VY, WZ, UX of the stator coil. The second electric current is greater than the first electric current, regardless of the correction factor K. Accordingly, the corrected second electric current is greater than the corrected first electric current if the intake air temperature Ti is as low as −30° C. The second electric current is smaller than the electric current to flow through each stator coil of the motor 10 in the forced commutation control process (see a solid line in FIG. 6). If the intake air temperature Ti is 0° C., the corrected second electric current will be at the value indicated by the virtual (dashed) line in FIG. 6. That is, the value will be 0.4 times that of the second electric current corrected with the intake air temperature Ti at −30° C. The second electric current will generally be greater than the rated electric current. If the intake air temperature Ti is between −30° C. and 0° C., the corrected second electric current will be at the value between the value indicated by the solid line in FIG. 6 and the value indicated by the virtual line.

As shown in FIG. 6, the rotation position of the rotor is fixed at a predetermined stop position, where the N-pole faces the stator coil Z. This may be done by allowing the corrected second electric current to flow through all the three phases VY, WZ, UX of the stator coil. In Step S64 of FIG. 4, it is determined whether 1.5 seconds has elapsed since the position fixing control process has started, thereby indicating that the position fixing control process of FIG. 4 has been completed. The reason for keeping the corrected second electric current flowing through all three phases of the stator coils, VY, WZ, and UX for 1.5 seconds is to ensure that the rotation position of the rotor has securely stopped at the predetermined stop position. In addition, during this 1.5 second time period, the stator coil of the motor 10 is heated, thereby promoting warming-up of the motor 10. The lower the intake air temperature Ti is, the greater the corrected first electric current and the corrected second electric current will be. Therefore, the warming-up process can be efficiently performed.

The processes of Steps S61 and S62 in FIG. 4 correspond to a guiding means or process (for, example, a guiding circuit, which is a part of the CPU 21). The processes of Steps S63 and S64 correspond to the stop fixing means or process (for example, a stop fixing circuit, which is a part of the CPU 21).

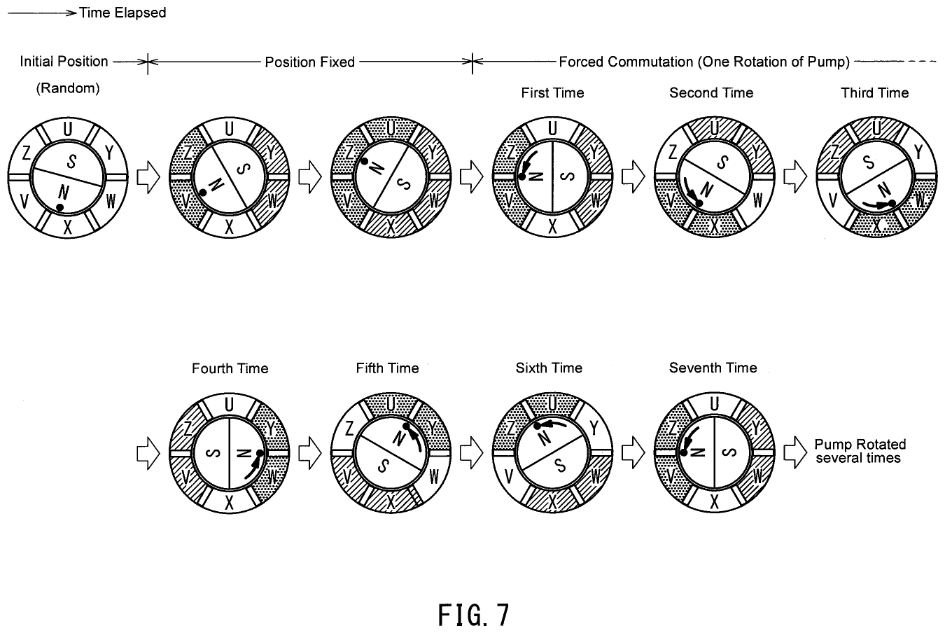

FIG. 7 schematically illustrates the operating state of the motor 10 when transitioning from the position fixing control process to the forced commutation control process. In the initial position before the position fixing control process starts, the stator coil of the motor 10 is not energized. Accordingly, the rotation position of the rotor (indicated by N, S in FIG. 7) is at a random position. When the position fixing control process starts, two phases, for instance phase VY and phase WX, of the three-phase stator coil are energized, as described-above. This may cause the rotor to rotate. In FIG. 7, the energized stator coils are illustrated by hatching and dots in order to distinguish them from the non-energized stator coils, which do not have a fill pattern. As a result of being energized, the stator is excited to the N-pole on the hatched side and the S-pole on the dotted side. When all the three phases VY, WZ, UX of the stator coil are energized afterwards, the rotation position of the rotor is fixed at the predetermined stop position, as described above.

Next, the forced commutation control process is started. In the forced commutation control process, the stator coil, which is to be energized during one rotation of the pump (rotor of the motor 10), is switched 7 times. At first (for the first switching time), the two-phases VY, WZ of the stator coil are energized and the rotor starts rotating from the stop position, in which the stator was stopped by the position fixing control process, in a direction indicated by the arrow in FIG. 7. After the second switching time, the stator coils to be energized are sequentially switched and the rotor is rotated as indicated by an arrow in FIG. 7. At the seventh switching time, the pump returns to the same rotation position as the first switching time, and thereafter, the above operation is repeated to continue rotating the rotor of the motor 10 to operate the pump.

According to a first embodiment, the motor 10 is intermittently operated at a rotation speed up to the predetermined start-up rotation speed. The predetermined start-up rotation is a speed in the phase before the rotation speed of the motor 10 reaches the rated rotation speed by the forced commutation control process. The intermittent operation may be performed when the motor is operated within a low temperature range, where the intake air temperature Ti is within a certain pre-determined range, such as greater than or equal to −30° C. and below 0° C. Therefore, a larger starting electric current, which in this embodiment is about four times greater than the rated electric current, flows through the stator coils of the motor 10. As such, the motor 10 can be efficiently warmed up. In addition, at this time, since the motor 10 is heated while rotating, the electric current varying in magnitude flows sequentially through the stator coils of the motor 10, thereby preventing local overheating of the stator coil. Further, the motor 10 rotates while being repeatedly heated at a lower rotation speed, for instance up to the start-up rotation speed. This reduces the viscosity of the grease in the bearings (not shown) provided on the rotating shaft of the motor 10. The reduced viscosity allows the grease to be settled for proper rotation of the bearings, while suppressing abnormal noise, vibration, etc. due to low-temperature operations associated with driving a motor. Further, constant electric currents (e.g., the corrected first electric current and the corrected second electric current) are allowed to flow through the stator coil of the motor 10 in order to stop the motor 10 before running it at a higher speed. Further, the lower the temperature of the motor 10 is, the greater the supplied constant electric current. Therefore, even while the motor 10 is stopped, it can be sufficiently heated in low temperature conditions, thereby further promoting the warming up of the motor 10. On the other hand, in high temperature conditions, overheating of the stator coils can be prevented by suppressing heating of the motor 10. As a result, the normal motor operation can be started quickly.

Further, regardless of the rotation position of the rotor of the motor 10, and regardless of whether or not the rotor had previously stopped rotating, the rotor may be rotated and guided toward the predetermined stop position by the guiding means of the position fixing control process. Subsequently, the rotor is stopped at the predetermined stop position by the stop fixing means of the position fixing control process. Therefore, the rotor may be reliably stopped regardless of the previous position or movement of the rotor. In addition, the forced commutation control process can be smoothly started by selecting the stop position at the position where the rotor is smoothly rotated during the forced commutation control process.

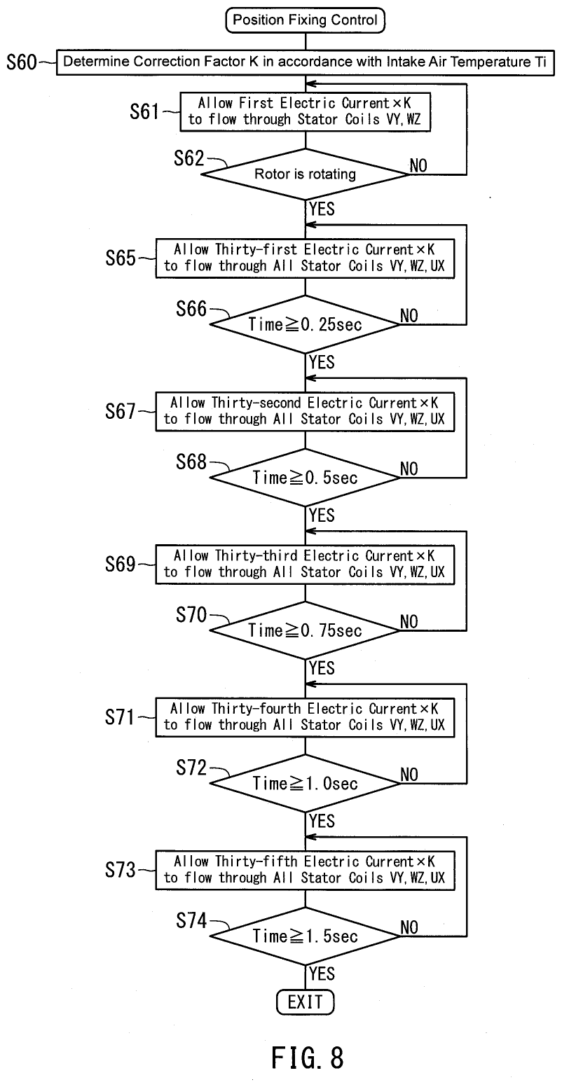

FIG. 8 shows a second exemplary embodiment. The changes made to the second embodiment as compared to the first embodiment (see FIG. 4) are primarily with regard to the stop fixing means of the position fixing control process. The other configurations of the second embodiment are substantially the same as those of the first embodiment. Therefore, the parts and steps that are substantially the same will not be described again.

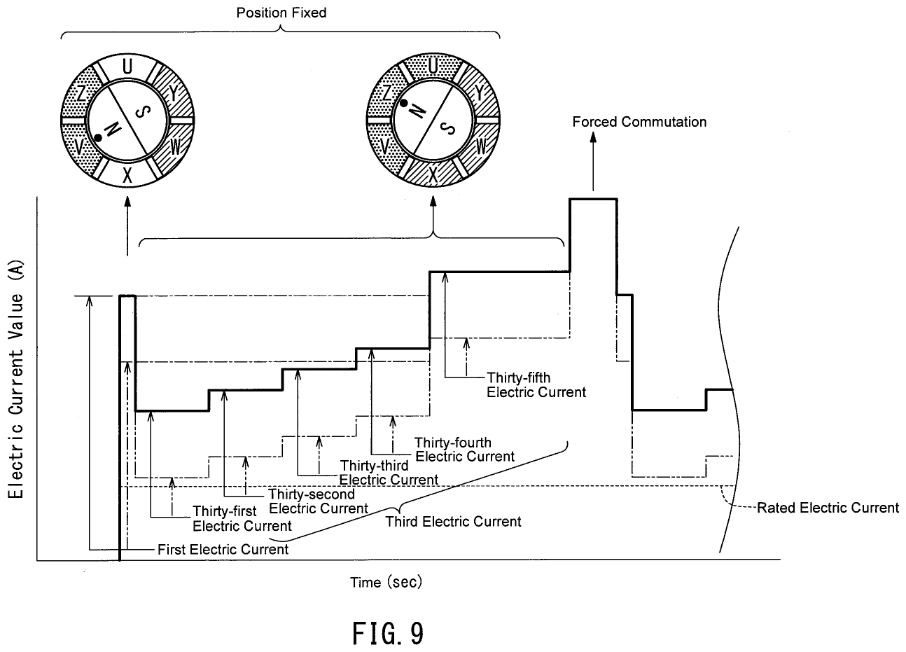

In FIG. 8, Steps S60 to S62 are generally the same as those of the first embodiment of FIG. 4. For instance, similar to FIG. 4, Step S62 is determined to be YES when the rotor of the motor 10 starts rotating. Thereafter, in the Step S65 in FIG. 8, a thirty-first electric current is allowed to flow through all the three-phases VY, WZ, and UX of the stator coil. The thirty-first electric current is less than the first electric current and greater than the rated electric current. The thirty-first electric current is also corrected by the correction factor K, which is determined in accordance with the intake air temperature Ti, as previously described with respect to the second electric current in the first embodiment. For instance, if the intake air temperature Ti is −30° C., it may be at the value indicated by a solid line in FIG. 9. Further, if the intake air temperature Ti is 0° C., the corrected thirty-first electric current may be at the value indicated by a virtual line (e.g., the two-dot-chain line) in FIG. 9. If the intake air temperature Ti is between −30° C. and 0° C., the thirty first electric current may be at the value between the values indicated by the solid line and the virtual line of FIG. 9.

Afterwards, every time it is determined that 0.25 seconds has elapses in Steps S66, S68, S70, and S72, the process proceeds to the next step, for instance Steps S67, S69, S71, and S73, respectively. In these steps, the electric current is gradually or stepwise increased to a thirty-second electric current, a thirty-third electric current, a thirty-fourth electric current, and a thirty-fifth electric current. Similar to the thirty-first electric current, the thirty-second electric current, the thirty-third electric current, the thirty-fourth electric current, and the thirty-fifth electric current are also be corrected by the correction factor K. The correction factor K is determined based on the intake air temperature Ti as previously described. For instance, if the intake air temperature Ti is −30° C., the corrected currents may be the values indicated by the solid line in FIG. 9, respectively. The thirty-second electric current, the thirty-third electric current, the thirty-fourth electric current, and the thirty-fifth electric current are at the values indicated by the virtual line (e.g., the dot-chain line) in FIG. 9 if the intake air temperature Ti is 0° C. The thirty-second electric current, the thirty-third electric current, the thirty-fourth electric current, and the thirty-fifth electric current are at values between the values indicated by the solid line and the virtual line in FIG. 9 if the intake air temperature Ti is between −30° C. and 0° C.

As shown in FIG. 9, the thirty-fifth electric current is determined to be greater than the first electric current and less than the electric current that is allowed to flow through each stator coil of the motor 10 in the forced commutation control process. Further, the thirty-first electric current, the thirty-second electric current, the thirty-third electric current, the thirty-fourth electric current, and the thirty-fifth electric current collectively represent a third electric current. The third electric current generally corresponds to the second electric current in the first embodiment.

Accordingly, similar to the second electric current, the rotation position of the rotor is fixed at a predetermined stop position where its N-pole faces the stator coil Z. In Step S73, the thirty-fifth electric current is allowed to flow through all the three-phases VY, WZ, and UX of the stator coil. Step S73 will continue until Step S74 is determined to be YES, which may be after the timer Time indicates that 1.5 seconds has passed since the position fixing control process started.

The processes of Steps S61 and S62 in FIG. 8 correspond to a guiding means or process (for example, a guiding circuit, which is a part of the CPU 21). The processes of Steps S65 to S74 correspond to the stop fixing means or process (for example a stop fixing circuit, which is a part of the CPU 21).

According to a second exemplary embodiment, the rotor of the motor 10 is stopped at a predetermined stop position by the stop fixing means. For instance, the rotor may be stopped after the rotor has been rotated and guided toward the predetermined stop position by the guiding means. At this time, the stop fixing means gradually and progressively increases the electric current flowing through the stator coils, for instance from the thirty-first electric current, which may be less than the first electric current, to the thirty-fifth electric current, which may be greater than the first electric current. This prevents an abrupt rotating motion of the rotor toward the stop position and enables the rotor to stably stop rotating at the stop position.

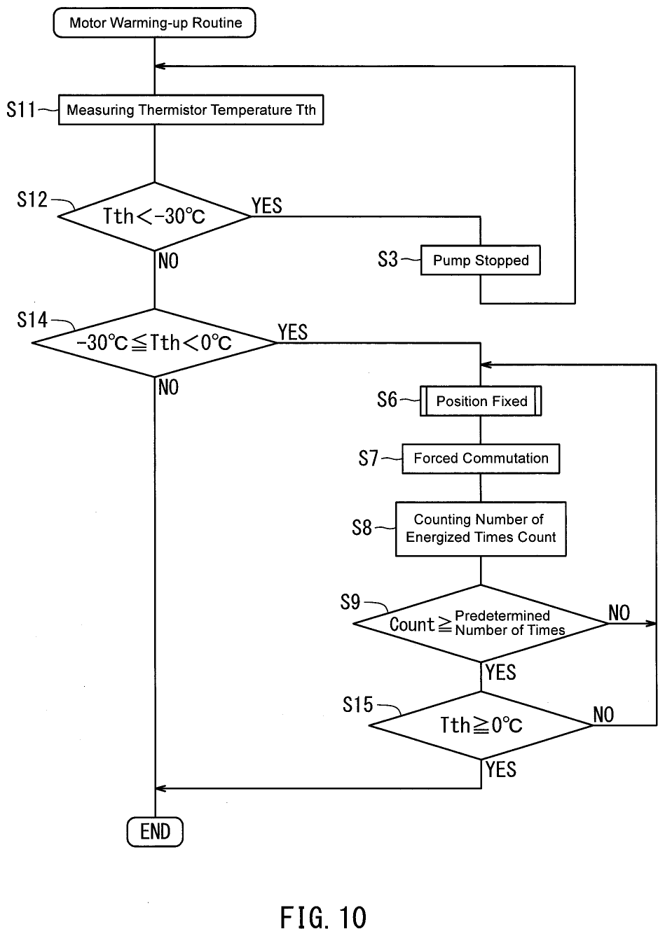

FIG. 10 shows a third exemplary embodiment. In the first embodiment of FIG. 2, the intake air temperature Ti is used as a temperature of the motor 10. Instead, in the third embodiment, a thermistor temperature Tth measured by a thermistor 4 (which is an example of a temperature sensor) is used as a temperature of a motor 10 for the motor driving circuit 20. Also, in the first embodiment, the time for intermittently operating the motor 10 is set to continue until the number of energized times Counts has reached a predetermined number of times and until the timer Time has reached a predetermined time. On the other hand, in the third embodiment shown in FIG. 10, the time for intermittently operating of the motor 10 continues until the number of energized numbers Counts has reached a predetermined number of times and until the thermistor temperature Tth has reached a predetermined temperature, for example, equal to or greater than 0° C. The other configurations of the third embodiment are essentially the same as those of the first embodiment, and, therefore, the parts and steps that are substantially the same will not be described again.

In FIG. 10, the thermistor temperature Tth is measured and logged in Step S11. In Step S12, it is determined whether or not the thermistor temperature Tth is below −30° C. If the thermistor temperature Tth is below −30° C., Step S12 is determined to be YES and the pump is stopped in Step S3. If the thermistor temperature Tth is greater than or equal to −30° C., Step S12 is determined to be NO. It is then determined whether or not the thermistor temperature Tth is greater than or equal to −30° C. and below 0° C. If the thermistor temperature Tth is greater than or equal to −30° C. and below 0° C., Step S14 is determined to be YES. Accordingly, the position fixing control process, similar to the first embodiment, is carried out in Step S6. Further, the forced commutation control process, similar to the first embodiment, will be carried out in Step S7.

In Step S8 and Step S9, it is determined whether or not the energized number of times Count of the motor 10 by the forced commutation control process has reached a predetermined number, for example 400 times. In the following Step S15, it is determined whether or not the thermistor temperature Tth has reached a predetermined temperature of, for example, equal to or greater than 0° C. If the energized number of times Count has not reached a predetermined number of times or if the thermistor temperature Tth has not reached a predetermined temperature, Step S9 or Step 15 is determined to be NO, and the processes from Step S6 onwards is repeated. Therefore, as shown in FIG. 3, the position fixing control process and the forced commutation control process will be repeatedly carried out. More specifically, the motor 10 is intermittently operated at the predetermined rotation speed, for instance up to start-up rotation speed. If Step S9 and Step S15 are determined to be YES, for instance after it has been determined that the energized number of times Count has reached a predetermined number of times and the thermistor temperature Tth has reached the predetermined temperature, the process for the motor warming-up routine is ended.

The process of Step S11 in FIG. 10, correspond to the temperature detecting means or process (for example a temperature detecting circuit, which is a part of the CPU 21). The processes of Steps S8, S9, S15 correspond to a normal operability determining means or process (for example, a normal operability determining circuit, which is a part of the CPU 21). The processes of Steps S6, S7, S8, S9, S15 correspond to the intermittent operation means or process (for example, an intermittent operation circuit, which is a part of the CPU 21).

In a third exemplary embodiment, basically the same operation and effect of the first embodiment can be achieved.

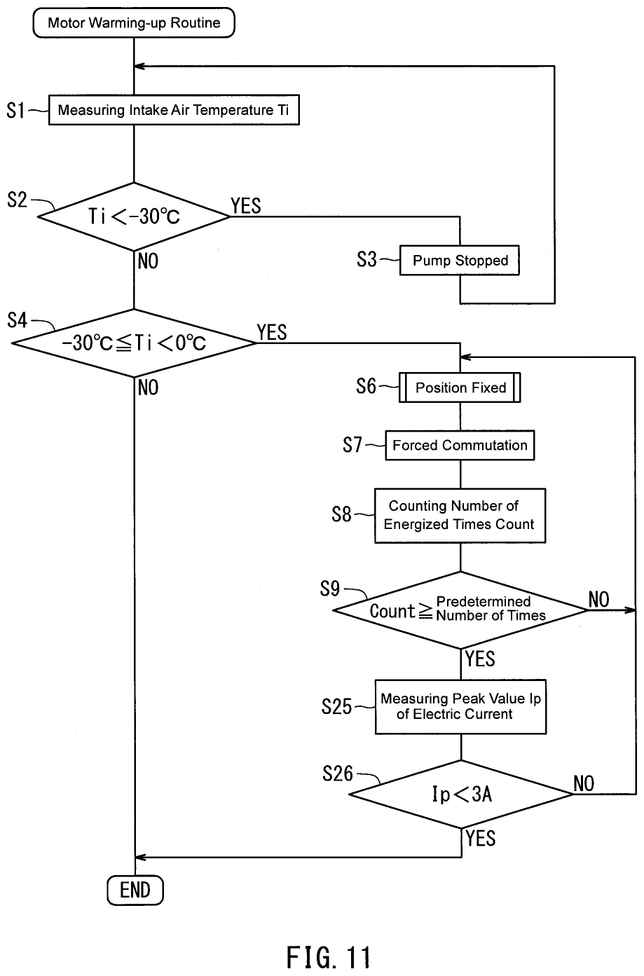

FIG. 11 shows a fourth exemplary embodiment. In the first embodiment of FIG. 2, the time for intermittent operation of the motor 10 is set until the energized number of times Count has reached a predetermined number of times and until the timer Time has reached the predetermined time. On the other hand, in the fourth embodiment, the time for intermittent operation of the motor 10 is set to the time until the energized number of times Count has reached a predetermined number of times and until a peak value Ip of the operation electric current of the motor 10 has reached a certain value, for example below 3A. The other configurations of the fourth embodiment are essentially the same as those of the first embodiment, and, therefore, the parts and steps that are substantially the same will not be described again.

In FIG. 11, Steps S1 to S4 are the same as those of the first embodiment. If Step 4 is determined to be YES, that is if the intake air temperature Ti is greater than or equal to −30° C. and below 0° C., the same position fixing control process as the first embodiment is performed in Step S6. Further, the same forced commutation control process as the first embodiment is performed in Step S7. Steps S8 and S9 are essentially the same as those of the first embodiment, in that it is determined whether or not the energized number of times Count of the motor 10 during the forced commutation control process has reached a predetermined number of times, for example 400 times. In the following Step S25, the peak value Ip of the electric current is measured when the pump is rotatably operated by the motor 10 (for instance under its rated load). In the subsequent Step S26, it is determined whether or not the peak value Ip is at the predetermined value, for example, below 3A. If the energized number of times Count has not reached the predetermined number of times or if the peak value Ip is greater than the predetermined value, that is if Step S9 or Step S26 is determined to be NO, the processes from Step S6 and onward are repeated. This causes the motor 10 to intermittently operate at a rotation speed up to the predetermined start-up rotation. If the energized number of times Count has reached a predetermined number of times and if the peak value Ip is below the predetermined electric current, Step S9 and Step S26 are determined to be YES. Accordingly, the process for the motor warming-up routine ends.

The processes of Steps S8, S9, S25, S26 of FIG. 11, correspond to the normal operability determining means or process (for example, a normal operability determining circuit, which is a part of the CPU 21). The processes of Steps S6, S7, S8, S9, S25, S26 correspond to the intermittent operation means or process (for example, an intermittent operation circuit, which is a part of the CPU 21).

In the fourth exemplary embodiment, basically the same operation and effect as the first embodiment can be achieved.

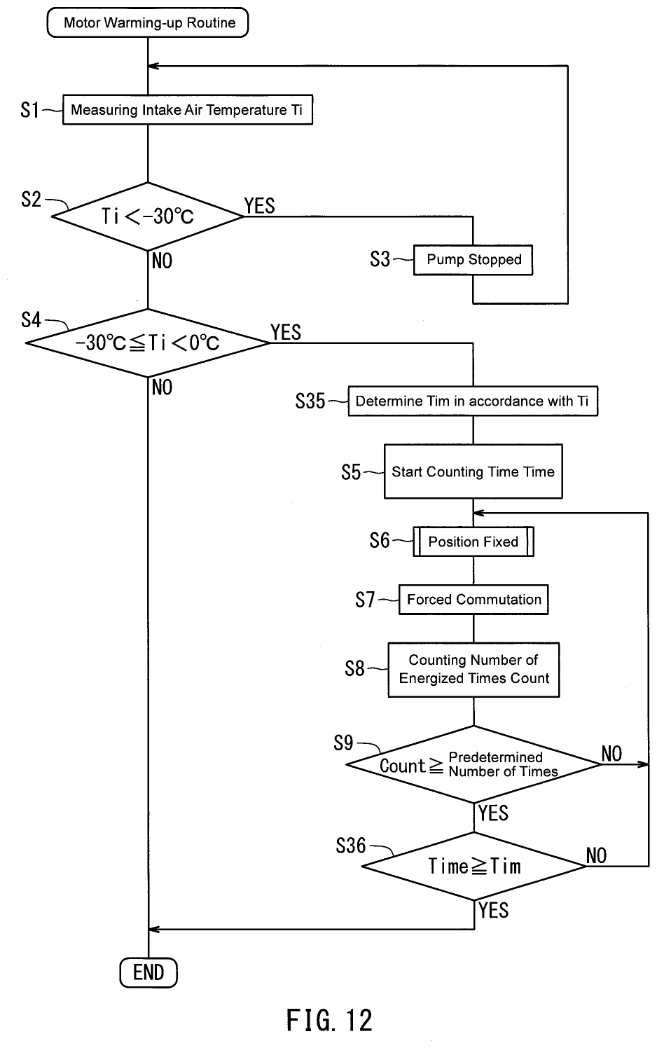

FIG. 12 shows a fifth embodiment. In the first embodiment of FIG. 2, the time for the intermittent operation of the motor 10 is set until the energized number of times Count has reached a predetermined number of times and until the timer Time has reached the predetermined time. On the other hand, in the fifth embodiment, the time for the intermittent operation of the motor 10 is set until a predetermined time of the timer Time has been reached. The predetermined time of the timer Time may be determined based on the intake air temperature Ti. The other configurations of the fifth embodiment are essentially the same as those of the first embodiment, and, therefore, the parts and steps that are substantially the same will not be described again.

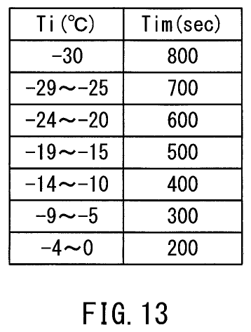

In FIG. 12, Steps S1 to S4 are essentially the same as those of the first embodiment. If the intake air temperature Ti is greater than or equal to −30° C. and below 0° C., Step S4 is determined to be YES. Thereafter, the predetermined time Tim of the timer Time is determined based on the intake air temperature Ti in Step S35. The predetermined time Tim may be a value stored in a map in advance in a memory unit of a computer. FIG. 13 shows an example of the contents of the map. As shown in FIG. 13, the predetermined time Tim is determined based on the intake air temperature Ti. As also shown in FIG. 13, the contents of the map may be such that the lower the intake air temperature Ti, the longer the predetermined time Tim will be.

In Step S5, the timer Time starts counting. Subsequently, the position fixing control process similar to the first embodiment is performed in Step S6. Further, in Step S7, the same forced commutation control process as the first embodiment is performed. Steps S8 and S9 are essentially the same as those of the first embodiment, in that it is determined whether or not the energized number of times Count of the motor 10 by the forced commutation control process has reached a predetermined number, for example 400 times. In the subsequent Step S36, it is determined whether or not the timer Time has reached the predetermined time Tim, the predetermined time Tim having been determined in Step S35. If the energized number of times Count has not reached the predetermined number of times or if the timer Time has not reached the predetermined time Tim, that is if Step S9 or Step S36 is determined to be NO, the processes from Step S6 and onward will be repeated. This causes the motor 10 to intermittently operate at a rotation speed up to the predetermined start-up rotation. If the energized number of times Count has reached the predetermined number of times and the timer Time has reached the predetermined time Tim, that is Step S9 and Step 36 are determined to be YES, the process for the motor warming-up routine will end.

The processes of Steps S35, S5, S8, S9, and S36 of FIG. 12 correspond to the normal operability determining means or process (for example, a normal operability determining circuit, which is a part of the CPU 21) of the first means. The processes of Steps S35, S5, S6, S7, S8, S9, and S36 correspond to the intermittent operation means or process (for example, an intermittent operation circuit, which is a part of the CPU 21).

In the fifth exemplary embodiment, basically the same operation and effect as the first embodiment can be achieved. In addition, the time during intermittent operation of the motor 10 is made longer if the intake air temperature Ti is lower and is made shorter if the intake air temperature Ti is higher. Therefore, the motor 10 can be warmed up as needed.

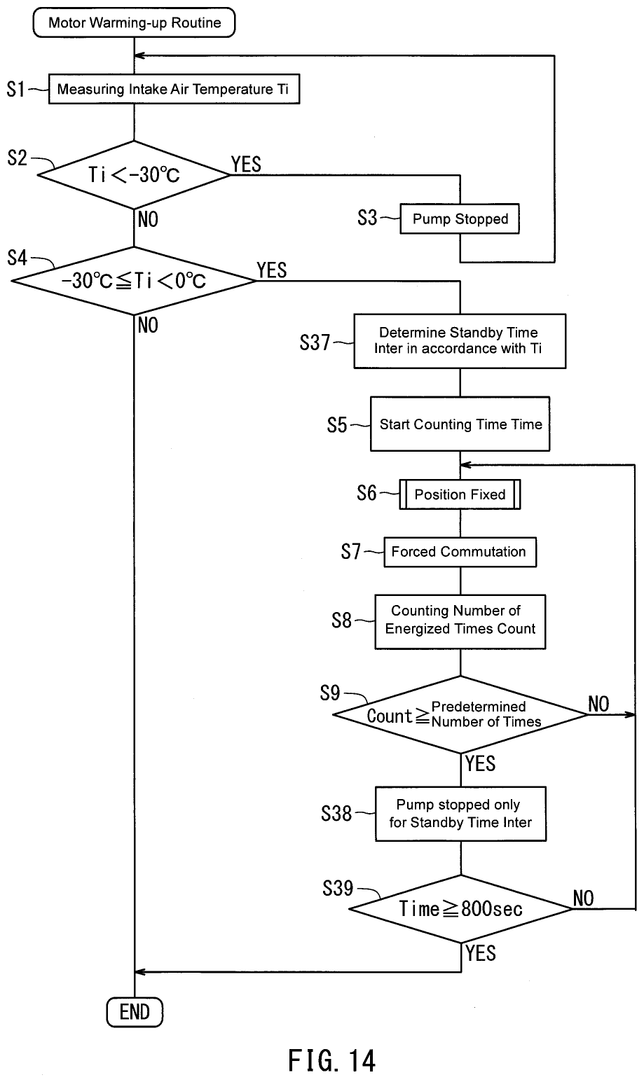

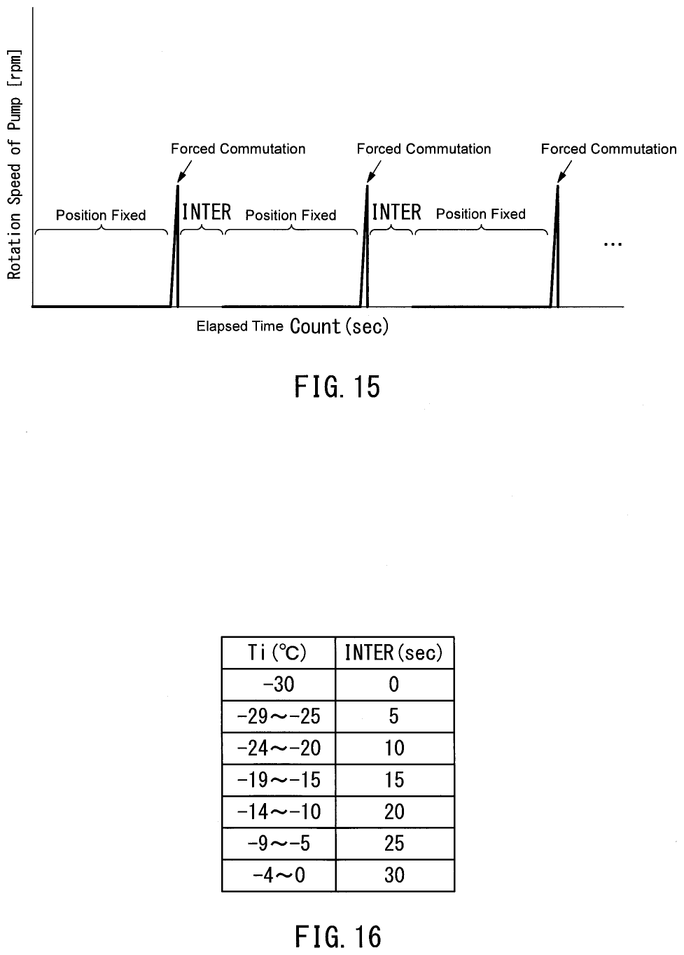

FIG. 14 shows a sixth embodiment. The sixth embodiment is different from the first embodiment (see FIG. 2) primarily in that a standby time Inter is set between the time the forced commutation is performed and the time the position fixing is performed. The other configurations of the sixth embodiment are essentially the same as those of the first embodiment, and, therefore, the parts and steps that are substantially the same not be described again.

In FIG. 14, Steps S1 to S4 are essentially to the same as those of the first embodiment. If the intake air temperature Ti is greater than or equal to −30° C. and below 0° C., Step 4 is determined to be YES. Thereafter, the standby time Inter is determined, for instance in accordance with the intake air temperature Ti. The standby time Inter is stored in advance in a map in the memory unit of the computer. FIG. 16 shows an embodiment of the contents of the map. As shown in FIG. 16, the standby time Inter is set in accordance with the intake air temperature Ti, and the lower the intake air temperature Ti, the shorter the time will be. The intake air temperature Ti, which in this embodiment is used to determine the standby time Inter, may be substituted for any other temperature, as long as it corresponds to the temperature of the motor itself or the temperature around the motor.

In Step S5, the timer Time starts counting. Subsequently, in Step S6, the same position fixing control process as in the first embodiment is performed. Further, in Step S7, the same forced commutation control process as in the first embodiment is performed. Steps S8 and S9 are essentially the same as those of the first embodiment. For instance, it is determined whether or not the energized number of times Count of the motor 10 during the forced commutation control process has reached a predetermined number, for example 400 times.

In Step S38, the pump is stopped for the standby time Inter, which was determined in Step S37. In the following Step S39, it is determined whether or not the timer Time has reached a predetermined time, for example 800 seconds. If the number of energized times Count has not reached the predetermined number of times or the timer Time has not reached the predetermined time, that is Step S9 or Step S39 is determined to be NO, the processes from Step S6 and onwards will be repeated. Therefore, the motor 10 is intermittently operated at a rotation speed up to the predetermined start-up rotation. If the number of energized times Count has reached the predetermined number of times and the timer Time has reached the predetermined time, that is Step S9 and Step S39 are determined to be YES, the process for the motor warming-up routine will end.

The processes of Steps S5, S8, S9, S39 of FIG. 14 correspond to a normal operability determining means or process (for example, normal operability determining circuit, which is a part of the CPU 21) of the first embodiment. The processes of Step S5, S6, S7, S8, S9, and S39 correspond to the intermittent means or process (for example, intermittent operation circuit, which is a part of the CPU 21). The process of Step S6 corresponds to a position fixing means or process (for example, position fixing circuit, which is a part of the CPU 21). The process of Step S7 corresponds to a forced commutation means (for example, forced commutation circuit, which is a part of the CPU 21). Further, the processes of Steps S37 and S38 correspond to an interval means or process (for example, interval circuit, which is a part of the CPU 21).

In the sixth exemplary embodiment, basically the same operation and effect as the first embodiment can be achieved. In addition, the standby time Inter is extended as the temperature of the motor 10 increases, which in turn extends the intermittent cycle of the start-up operation that allows the start-up rotation of the motor. This enables an appropriate warming up of the stator coils without overheating the stator coils of the motor 10.

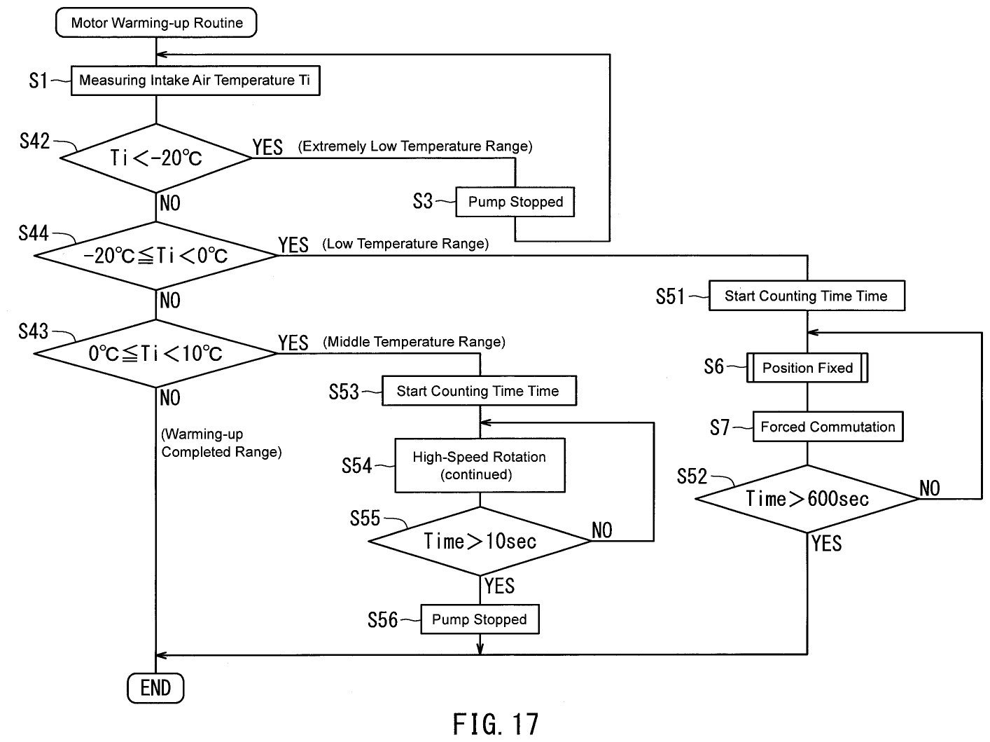

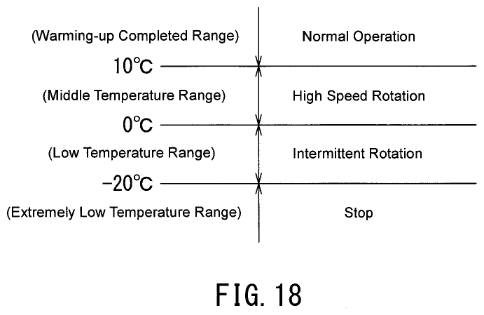

FIG. 17 shows a seventh embodiment. The seventh embodiment is different from the first embodiment (see FIG. 2) primarily in that a temperature range is divided into four ranges, such as an extremely low temperature range, a low temperature range, a middle temperature range, and a warming-up completed range as shown in FIG. 18. Additionally, the seventh embodiment differs from the first embodiment in that the motor 10 is allowed to rotate at high speed in the middle temperature range, as shown in FIG. 18. The high speed rotation in this case is a rotation greater than the rotation speed of the motor 10 during the forced commutation control process and less than the rated rotation speed of the motor 10 after the warming-up has been completed. The other configurations of the seventh embodiment are essentially the same as those of the first embodiment, and, therefore, the parts and steps that are substantially the same will not be described again.

In Step S1 in FIG. 17, the intake air temperature Ti is measured, similar to the first embodiment. In Steps S42, S44, S43, the range within which the intake air temperature Ti is located is determined. For example, it is determined if the intake air temperature Ti is within the extremely low temperature range (e.g., below −20° C.), the low temperature range (e.g., greater than or equal to −20° C. and below 0° C.), the middle temperature range (e.g., greater than or equal to 0° C. and below 10° C.), or the warming-up completed range (e.g., greater than or equal to 10° C.). If the intake air temperature Ti is in the extremely low temperature range, Step S42 is determined to be YES. Accordingly, the pump is stopped in Step S3, similar to the first embodiment. If the intake air temperature Ti is in the low temperature range, Step S44 is determined to be YES. Accordingly, the timer Time starts counting in Step S51, similar to the first embodiment. In the following Step S6, the position fixing control process is performed, and in Step S7, the forced commutation control process is performed. The control of Steps S6, S7 will be repeated until the timer Time reaches the predetermined time, for example 600 seconds. Accordingly, the motor 10 is intermittently operated at a rotation speed up to the predetermined start-up rotation speed.

If the intake air temperature Ti is in the middle temperature range, Step S43 is determined to be YES. Thereafter, the timer Time start counting in Step S53. In the following Step S54, the motor 10 is continuously rotated at high speed. Step S55 is determined to be NO until the timer Time reaches the predetermined time, for example 10 seconds. The motor 10 continues to rotate at high speed in Step S54. Once the timer Time has reached the predetermined time, the pump (motor 10) stops operating in Step S56. If the intake air temperature Ti is in the warming-up completed range, that is all of Steps S42, S44, S43 are determined to be NO, the process of the pump (motor) warming-up routine ends.

As shown in FIG. 18, for each temperature with the temperature ranges divided into the four ranges, including the extremely low temperature range, the low temperature range, the middle temperature range, and the warming-up completed range, −20° C. corresponds to the first temperature, 0° C. corresponds to the second temperature, and 10° C. corresponds to the third temperature.

The processes of Steps S42, S44, and S43 in FIG. 17 correspond to the temperature range determining means or process (e.g., temperature range determining circuit, which is a part of the CPU 21). The process of Step S3 corresponds to the motor stopping means or process (e.g., motor stopping circuit, which is a part of the CPU 21). The processes of Steps S53, S54, S55, and S56 correspond to the high-speed rotation means or process (e.g., high-speed rotation circuit, which is a part of the CPU 21). Further, the processes of Steps S51 and S52 correspond to the normal operability determining means or process (e.g., normal operability determining circuit, which is a part of the CPU 21). The processes of Steps S6, S7, S51, and S52 correspond to the intermittent operation means or process (e.g., intermittent operation circuit, which is a part of the CPU 21). The process of Step S6 corresponds to the position fixing means or process (e.g., position fixing circuit, which is a part of the CPU 21), and the process of Step S7 corresponds to the forced commutation means or process (e.g., forced commutation circuit, which is a part of the CPU 21).

In a seventh embodiment, the position fixing control process and the forced commutation control process are performed in the low temperature range, similar to the first embodiment. Therefore, basically the same operation and effect as the first embodiment can be achieved. In addition, the motor is rotated at a speed greater than the start-up rotation speed and the grease in the bearings is settled during the shorter rotation time in the middle temperature range. Therefore, the warming-up process can be controlled according to the initial temperature, which allows the normal motor operation of the motor to be started as quick as possible.

Although the technology disclosed in this specification has been described above in terms of specific embodiments, it can be carried out in various other forms. For example, in the above embodiments, a motor 10 is used for operating a pump. However, the use of the motor 10 shall not be limited thereto. Further, in the above embodiments, the motor 10 is a brushless motor. However, the structure of the motor shall not be limited thereto. Furthermore, in the above embodiments, an intake air temperature of an engine and a temperature of the motor driving circuit 20 are used as the temperature of the motor 10 itself or the temperature around the motor 10. However, another temperature, such as an engine cooling water temperature, an engine oil temperature, or the like, may be used. Moreover, in the second embodiment, the process is controlled such that the third electric current is gradually increased by the stop fixing means. However, the current may instead be continuously and gradually increased.

The control circuit 21 may include at least one programmed electronic processor. The control circuit 21 may include at least one memory configured to store instructions or software executed by the electronic processor to carry out at least one of the functions of the control circuit 21 described herein. For example, in some embodiments, the control circuit 21 may be implemented as a microprocessor with a separate memory.

The memory unit may include a volatile or a non-volatile memory. Examples of suitable memory unit may include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof.

Where the term “processor” or “central processing unit” or “CPU” is used for identifying a unit performing specific functions, it should be understood that, unless otherwise stated, those functions can be carried out by a single processor, or multiple processors arranged in any form, including parallel processors, serial processors, tandem processors, or cloud processing/cloud computing configurations. The software may include, for example, firmware, one or more applications, program data, filters, rules, one or more program modules, and/or other executable instructions.

The various examples described in detail above, with reference to the attached drawings, are intended to be representative of the present disclosure, and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, so as to provide an improved motor controller, and/or methods of making and using the same.

What is claimed is:

1. A motor controller, comprising:
a temperature sensor configured to detect a temperature of a motor or a temperature proximal the motor;
a normal operability determining circuit configured to determine whether the motor is in a normally operable state, wherein the normally operable state is a state where it is not necessary to take into account that the motor is operating at a low temperature; and
an intermittent operation circuit configured to intermittently operate the motor at a rotation speed up to a predetermined start-up rotation speed that is below a rotation speed of the motor once it reaches a rated rotation speed, wherein the intermittent operation circuit is configured to intermittently operate the motor until the normal operability determining circuit determines that the motor is in the normally operable state when the temperature detected by the temperature sensor is within a predetermined low temperature range during the operation of the motor,
wherein the intermittent operation circuit comprises:
a position fixing circuit configured to flow a constant electric current through a plurality of stator coils of the motor so as to fix the motor in a stopped state, and
a forced commutation circuit configured to rotate the motor at the rotation speed up to the start-up rotation speed,
wherein the constant electric current of the position fixing circuit is based on the temperature detected by the temperature sensor,
wherein the constant electric current is configured to be greater if the detected temperature is lower, and
wherein the position fixing circuit and the forced commutation circuit are configured to operate alternately.

2. The motor controller of claim 1, wherein the position fixing circuit comprises:
a guiding circuit configured to flow a first electric current to fewer than all of the plurality of stator coils of the motor and guide the rotor of the motor toward a stop position, wherein the first electric current is greater than a rated electric current and less than an electric current flowing through the stator coils of the motor when rotated by the forced commutation circuit, and
a stop fixing circuit configured to flow a second electric current through all the stator coils of the motor and stop the rotor of the motor at the stop position, wherein the second electric current is greater than the first electric current and less than the electric current flowing through the stator coils of the motor rotated by the forced commutation circuit.

3. The motor controller of claim 1, wherein the position fixing circuit comprises:
a guiding circuit configured to flow a first electric current through less than all of the plurality of stator coils of the motor and guide the rotor of the motor toward a stop position, wherein the first electric current is greater than a rated electric current and smaller than an electric current flowing through the stator coils of the motor while rotated by the forced commutation circuit, and
a stop fixing circuit configured to flow a second electric current through all the plurality of stator coils of the motor and stop the rotor of the motor at the stop position, wherein the second electric current is greater than a rated electric current and smaller than an electric current flowing through the stator coils of the motor when rotated by the forced commutation circuit,
wherein the motor controller is configured to gradually increase the second electric current from a value smaller than the first electric current to a value greater than the first electric current.

4. The motor controller of claim 1, wherein the intermittent operation circuit includes an interval circuit configured to delay starting of the position fixing circuit for a standby time after the forced commutation circuit is operated,
wherein the standby time of the interval circuit is set longer as the temperature measured by temperature sensor is higher.

5. The motor controller of claim 1, further comprising:
a temperature range determining circuit configured to determine that the temperature detected by the temperature sensor is:
in an extremely low temperature range that is less than a predetermined first temperature,
in a low temperature range that is between the predetermined first temperature and a second temperature that is greater than the predetermined first temperature, and
in a middle temperature range that is between the second temperature and a third temperature that is greater than the second temperature;
a motor stopping circuit configured to keep stopping the motor when the temperature range determining circuit determines that the temperature is in the extremely low temperature range; and
a high-speed rotation circuit configured to rotate the motor at a speed that is greater than the rotation speed by the forced commutation circuit and less than the rated rotation speed when the temperature range determining circuit determines that the temperature is in the middle temperature range,
wherein the intermittent operation circuit is configured to intermittently operate the motor when the temperature range determining circuit determines that the temperature is in the low temperature range.

6. The motor controller of claim 1, wherein the normal operability determining circuit is configured to determine that the motor is in the normally operable state when:
a predetermined time since the intermittent operation circuit started operating has elapsed,
the temperature measured by the temperature sensor is greater than or equal to a normally operable temperature threshold,
an operating electric current under a rated load of the motor is less than or equal to a predetermined electric current, or
the number of times the intermittent operation circuit performed an intermittent operation is greater than or equal to a predetermined number of times.
